(19) United States
(12) Patent Application Publication
(10) Pub. No.: US 2022/0371941 A1
(43) Pub. Date: Nov. 24, 2022

(54) GLASS PLATE AND METHOD FOR MANUFACTURING GLASS PLATE

(71) Applicant: Nippon Electric Glass Co., Ltd., Shiga (JP)

(72) Inventors: Yasushi KII, Shiga (JP); Kimiyasu OKUMURA, Shiga (JP)

(21) Appl. No.: 17/769,844

(22) PCT Filed: Oct. 26, 2020
(86) PCT No.: PCT/JP2020/040046

§ 371 Date: Apr. 18, 2022

(30) Foreign Application Priority Data
Nov. 6, 2019 (JP) 2019-201291

(51) Int. Cl. C03C 3/091; C03B 5/18; C03B 32/00

(52) U.S. Cl. CPC C03C 3/091; C03B 5/18; C03B 32/00

(57) ABSTRACT

A glass sheet of the present invention releases CO₂ gas in an amount of 5.0 μL/g or less when the glass sheet is subjected to heat treatment under the conditions of 1,500° C. and 4 hours after having been subjected to preheating under the conditions of 900° C. and 1 hour.

### TECHNICAL FIELD

The present invention relates to a glass sheet and a method of manufacturing a glass sheet, and more particularly, to a glass sheet used as a substrate of a liquid crystal display or an OLED display, and to a method of manufacturing a glass sheet.

### BACKGROUND ART

In the production of a glass sheet, how to remove or prevent bubbles in molten glass has heretofore been an issue. In particular, the level of bubble quality required for a glass sheet used as a substrate of a liquid crystal display or an OLED display has been rising year by year along with upsizing, and hence it has become more important to solve the above-mentioned issue.

A method of removing bubbles in molten glass is called fining. The most general fining method is a method including adding a fining agent. Specifically, the method includes adding a fining agent to glass raw materials, and generating, in a fining step, fining gas from the fining agent to enlarge bubbles in molten glass, to thereby perform floatation degassing. Specific examples of the fining agent include SnO₂ and Cl (see Patent Literature 1).

In addition, in Patent Literature 2, as a measure for bubbles that occur when an electrical circuit is formed by heating molten glass through application of a current, there is a disclosure of a method of, when a DC current has a DC current density which exceeds a DC current density at which bubbles occur, applying a reverse voltage which generates a current in a reverse direction from the DC current.

Further, in Patent Literature 3, as a method of suppressing bubbles resulting from carbon contamination of a platinum member, there are disclosures of a method of coating the platinum member with an oxygen-generating material, and a method of subjecting the platinum member to heat treatment in an atmosphere having a certain or higher oxygen concentration.

### CITATION LIST

Patent Literature 1: JP 6323730 B2
Patent Literature 2: JP 5863836 B2
Patent Literature 3: JP 5695530 B2

### SUMMARY OF INVENTION

### Technical Problem

A phenomenon in which bubbles occur in molten glass free of bubbles by the external factor as described above is called reboil. The reboil is caused by various factors. An example thereof is stirring reboil caused by stirring with a stirrer in a stirring step of homogenizing heterogeneous molten glass. Specifically, molten glass on a melting bath surface of a melting furnace is known to have a higher SiO₂ concentration than that of molten glass having an intended composition, and hence when the molten glass on the melting bath surface of the melting furnace is stirred together with the molten glass having an intended composition, bubbles may be caused by stirring reboil.

When the rotation speed of the stirrer is reduced, the stirring reboil is suppressed. However, in this case, there is a problem in that homogeneity of the molten glass after the stirring may be reduced.

The stirring step is often performed in a downstream side of the fining step in a manufacturing process for a glass sheet. Accordingly, it is difficult to remove bubbles caused by the stirring reboil in the fining step. Accordingly, there is a high risk in that the bubbles caused by the stirring reboil remains in a glass product as a bubble defect.

The present invention has been made in view of the above-mentioned circumstances, and a technical object of the present invention is to provide a glass sheet having no bubbles caused by stirring reboil remaining therein and a method of manufacturing a glass sheet that hardly causes stirring reboil.

### Solution to Problem

The inventors of the present invention have made various experiments, and as a result, have found that a main component of the stirring reboil that occurs when molten glass having a high SiO₂ concentration flows into a stirring bath is CO₂ gas, and also found that the above-mentioned technical object can be achieved by reducing the dissolved amount of CO₂ gas. The finding is proposed as the present invention. That is, according to one embodiment of the present invention, there is provided a glass sheet, which releases CO₂ gas in an amount of 5.0 μL/g or less when the glass sheet is subjected to heat treatment under the conditions of 1,500° C. and 4 hours after having been subjected to preheating under the conditions of 900° C. and 1 hour. The “amount of CO₂ gas released when the glass sheet is subjected to heat treatment under the conditions of 1,500° C. and 4 hours after having been subjected to preheating under the conditions of 900° C. and 1 hour” is obtained as described below. A glass is pulverized into a size of from 2.0 mm to 5.6 mm, classified, washed, and dried, 1.0 g of the glass is weighed as a measurement sample, the glass is subjected to preheating under the conditions of 900° C. and 1 hour to remove CO₂ gas adsorbed on a glass surface, and is then subjected to heat treatment under the conditions of 1,500° C. and 4 hours, and the total amount of CO₂ gas released during this period of time is measured with a mass spectrometer as a volume in a standard state (0° C. and 100 kPa).

The stirring reboil is considered to be a phenomenon in which a gas that cannot be dissolved in molten glass is changed to bubbles due to a reduction in gas solubility in the molten glass caused by contact between glasses having different compositions or a reduction in pressure of the molten glass by the rotation of the stirrer. Accordingly, when the dissolved amount of CO₂ gas in the molten glass is reduced in advance, CO₂ bubbles caused by the stirring reboil can be reduced. In addition, the occurrence of the stirring reboil can be effectively suppressed even when the gas solubility in the molten glass is temporarily reduced by stirring.

In addition, it is preferred that the glass sheet according to the one embodiment of the present invention comprise as a glass composition, in terms of the following oxides in mass %, 50% to 70% of SiO₂, 15% to 22% of Al₂O₃, 0.1% to 15% of B₂O₃, 0% to 8% of MgO, 3% to 10% of CaO, 0% to 8% of SrO, and 0% to 15% of BaO, and be substantially free of an alkali metal oxide.

In addition, it is preferred that the glass sheet according to the one embodiment of the present invention have a temperature at 10^{2.5} dPa·s of from 1,530° C. to 1,680° C. The “temperature at 10^{2.5} dPa·s” may be measured by a well-known platinum sphere pull up method.

In addition, it is preferred that the glass sheet according to the one embodiment of the present invention be used as a substrate of a liquid crystal display or an OLED display.

According to one embodiment of the present invention, there is provided a method of manufacturing a glass sheet, comprising: a blending step of blending and mixing glass raw materials so that a glass having a temperature at 10^{2.5} dPa·s of from 1,530° C. to 1,680° C. is obtained, to thereby produce a glass batch; a melting step of loading the glass batch into a melting furnace to obtain molten glass; a fining step of fining the molten glass; a stirring step of stirring the molten glass after the fining step at a temperature of 1,550° C. or less; and a forming step of, after supplying the molten glass after the stirring into a forming apparatus, forming the molten glass into a sheet shape to obtain a glass sheet.

As the temperature becomes higher, the solubility of CO₂ gas in the molten glass tends to be reduced. Accordingly, when the molten glass is stirred at a low temperature of 1,550° C. or less in the stirring step, the stirring reboil can be effectively suppressed.

In addition, it is preferred that, in the method of manufacturing a glass sheet according to the one embodiment of the present invention, the forming step comprise forming the molten glass into a sheet shape to obtain a glass sheet which releases CO₂ gas in an amount of 8.0 μL/g or less when the glass sheet is subjected to heat treatment at 1,500° C. for 4 hours after having been subjected to preheating at 900° C. for 1 hour.

### Advantageous Effects of Invention

According to the present invention, the glass sheet having a small amount of stirring reboil can be provided.

### BRIEF DESCRIPTION OF DRAWINGS

FIG. 1 is a graph showing CO₂ gas release rates of a glass A and a glass B in the section of Examples when the glasses are each subjected to heat treatment at 1,500° C. for 4 hours.

### DESCRIPTION OF EMBODIMENTS

In a glass sheet of the present invention, the amount of CO₂ gas released when the glass sheet is subjected to heat treatment under the conditions of 1,500° C. and 4 hours after having been subjected to preheating under the conditions of 900° C. and 1 hour is 5.0 μL/g or less, preferably 3.0 μL/g or less, more preferably 2.0 μL/g or less. When the amount of CO₂ gas released when the glass sheet is subjected to the heat treatment is too large, the number of bubbles in glass caused by stirring reboil becomes excessively large.

As methods of reducing the amount of CO₂ gas released when the glass sheet is subjected to the heat treatment (the amount of CO₂ gas dissolved in the glass), there are given the following methods (1) to (4): (1) using an oxide raw material instead of using a carbonate raw material as a glass raw material; (2) subjecting glass raw materials to preheating to remove impurities each containing carbon; (3) reducing a CO₂ concentration in a melting atmosphere; and (4) subjecting molten glass to decompression treatment.

It is preferred that the glass sheet of the present invention comprise as a glass composition, in terms of the following oxides in mass %, 50% to 70% of SiO₂, 15% to 22% of Al₂O₃, 0.1% to 15% of B₂O₃, 0% to 8% of MgO, 3% to 10% of CaO, 0% to 8% of SrO, and 0% to 15% of BaO, and be substantially free of an alkali metal oxide. The reason why the glass composition of the glass sheet is limited as described above is shown below. In the description of the content range of each component, the expression “%” represents “mass %”.

SiO₂ is a component that forms the skeleton of the glass. The content of SiO₂ is preferably from 50% to 70%, from 54% to 68%, or from 56% to 66%, particularly preferably from 58% to 64%. When the content of SiO₂ is too low, a density becomes too high, and acid resistance is liable to be reduced. Meanwhile, when the content of SiO₂ is too high, a viscosity at high temperature is liable to be increased to reduce meltability. Besides, a devitrified crystal such as cristobalite is liable to precipitate, and a liquidus temperature is liable to be increased.

Al₂O₃ is a component that forms the skeleton of the glass, and is also a component that enhances a strain point and a Young's modulus. Further, Al₂O₃ is a component that suppresses phase separation. The content of Al₂O₃ is preferably from 15% to 22%, particularly preferably from 16% to 21%. When the content of Al₂O₃ is too low, the strain point and the Young's modulus are liable to be reduced, and besides, the glass is liable to undergo phase separation. Meanwhile, when the content of Al₂O₃ is too high, a devitrified crystal, such as mullite or anorthite, is liable to precipitate, and the liquidus temperature is liable to be increased.

B₂O₃ is a component that enhances the meltability, and also enhances devitrification resistance. The content of B₂O₃ is preferably from 0.1% to 15%, from 0.3% to 10%, or from 0.5% to 8%, particularly preferably from 1% to 7%. When the content of B₂O₃ is too low, the meltability and the devitrification resistance are liable to be reduced, and besides, resistance to a hydrofluoric acid-based chemical liquid is liable to be reduced. Meanwhile, when the content of B₂O₃ is too high, the Young's modulus and the strain point are liable to be reduced.

MgO is a component that reduces the viscosity at high temperature to enhance the meltability, and is a component that remarkably enhances the Young's modulus among alkaline earth metal oxides. The content of MgO is preferably from 0% to 8%, from 0% to 7%, from 0% to 6%, or from 0% to 3%, particularly preferably from 0% to 2%. When the content of MgO is too low, the meltability and the Young's modulus are liable to be reduced. Meanwhile, when the content of MgO is too high, the devitrification resistance is liable to be reduced, and besides, the strain point is liable to be reduced.

CaO is a component that reduces the viscosity at high temperature to remarkably enhance the meltability without reducing the strain point. In addition, a raw material for introducing CaO is relatively inexpensive among those for alkaline earth metal oxides, and hence CaO is a component that achieves a reduction in raw material cost. The content of CaO is preferably from 3% to 10% or from 4% to 10%, particularly preferably from 5% to 9%. When the content of CaO is too low, it becomes difficult to exhibit the above-mentioned effects. Meanwhile, when the content of CaO is too high, the glass is liable to devitrify, and besides, a thermal expansion coefficient is liable to be increased.

SrO is a component that suppresses the phase separation, and enhances the devitrification resistance. Further, SrO is a component that reduces the viscosity at high temperature to enhance the meltability without reducing the strain point, and is also a component that suppresses an increase in liquidus temperature. The content of SrO is preferably from 0% to 8% or from 0.1% to 7%, particularly preferably from 0.5% to 6%. When the content of SrO is too low, it becomes difficult to exhibit the above-mentioned effects. Meanwhile, when the content of SrO is too high, a strontium silicate-based devitrified crystal is liable to precipitate, and the devitrification resistance is liable to be reduced.

BaO is a component that remarkably enhances the devitrification resistance. The content of BaO is preferably from 0% to 15%, from 0% to 12%, or from 0.1% to 9%, particularly preferably from 1% to 7%. When the content of BaO is too low, it becomes difficult to exhibit the above-mentioned effects. Meanwhile, when the content of BaO is too high, the density becomes too high, and the meltability is liable to be reduced. In addition, a devitrified crystal containing BaO is liable to precipitate, and the liquidus temperature is liable to be increased.

SnO₂ is a component that acts as a fining agent. The content of SnO₂ is preferably from 0% to 1% or from 0.1% to 0.5%, particularly preferably from 0.2% to 0.4%. When the content of SnO₂ is too high, a devitrified crystal is liable to precipitate, and the liquidus temperature is liable to be increased.

It is preferred that the glass sheet be substantially free (that is, 0.1% or less) of alkali metal oxides (Li₂O, Na₂O, and K₂O).

In addition to the above-mentioned components, any other components, for example, a component, such as ZrO₂, ZnO, P₂O₅, or Mo, may be added. The content of the other component than the above-mentioned components is preferably 10% or less, particularly preferably 5% or less in terms of total content, from the viewpoint of appropriately exhibiting the effects of the present invention.

In the glass sheet of the present invention, the strain point is preferably 680° C. or more or 690° C. or more, particularly preferably 700° C. or more. When the strain point is too low, the glass sheet is liable to be thermally shrunk in heat treatment in a manufacturing process for a display. Meanwhile, when the strain point is too high, the manufacturing cost of the glass sheet is liable to rise.

In the glass sheet of the present invention, the temperature at 10^{2.5} dPa·s is preferably from 1,530° C. to 1,680° C., more preferably from 1,550° C. to 1,650° C., particularly preferably from 1,580° C. to 1,630° C. When the temperature at 10^{2.5} dPa·s is too low, the glass sheet is liable to be thermally shrunk in heat treatment in a manufacturing process for a display. Meanwhile, when the temperature at 10^{2.5} dPa·s is too high, the meltability is reduced, and hence the manufacturing cost of the glass sheet is liable to rise. As the temperature at 10^{2.5} dPa·s becomes higher, bubbles caused by the stirring reboil are liable to remain. Accordingly, as the temperature at 10^{2.5} dPa·s becomes higher, the effects of the present invention relatively increase.

A method of manufacturing a glass sheet of the present invention is characterized by comprising: a blending step of blending and mixing glass raw materials so that a glass having a temperature at 10^{2.5} dPa·s of from 1,530° C. to 1,680° C. is obtained, to thereby produce a glass batch; a melting step of loading the glass batch into a melting furnace to obtain molten glass; a fining step of fining the molten glass; a stirring step of stirring the molten glass after the fining step at a temperature of 1,550° C. or less; and a forming step of, after supplying the molten glass after the stirring into a forming apparatus, forming the molten glass into a sheet shape to obtain a glass sheet. Now, the method of manufacturing a glass sheet of the present invention is described in detail.

First, the glass raw materials serving as introduction sources for the respective components are blended and mixed so that a glass having a temperature at 10^{2.5} dPa·s of from 1,530° C. to 1,680° C. is obtained, to thereby produce a glass batch. A glass cullet may be used as the glass raw material as required. The glass cullet is a glass waste discharged in, for example, a glass manufacturing process. The method of mixing the glass raw materials is not particularly limited, and may be appropriately selected in accordance with the masses of the glass raw materials to be mixed at one time or the kinds of the glass raw materials. An example thereof is a mixing method with a pan-type mixer or a rotary mixer.

From the viewpoint of reducing the amount of CO₂ gas released from the glass sheet in the heat treatment, it is preferred that an oxide raw material be used as the glass raw material, instead of a carbonate raw material, and it is also preferred that the glass raw materials be subjected to preheating to remove impurities each containing carbon.

Next, the obtained glass batch is loaded into a melting furnace. The loading of the glass batch into the melting furnace is typically continuously performed by a raw material feeder such as a screw charger, but may also be intermittently performed.

The glass batch loaded into the melting furnace is heated by, for example, a combustion atmosphere provided by a burner or the like, or an electrode arranged inside of the melting furnace to become molten glass. The melting temperature of the glass batch is from about 1,530° C. to about 1,680° C. From the viewpoint of reducing the amount of CO₂ gas released from the glass sheet in the heat treatment, it is preferred that the CO₂ concentration in a melting atmosphere be reduced, and it is also preferred that the molten glass be subjected to decompression treatment.

Subsequently, the obtained molten glass is subjected to the fining step, the stirring step, and a supplying step, and is then gradually cooled in order to be loaded into the forming apparatus.

A process temperature in the stirring step is 1,550° C. or less, preferably 1,500° C. or less, more preferably 1,450° C. or less. When the process temperature in the stirring step is too high, the stirring reboil is hardly suppressed.

In the method of manufacturing a glass sheet of the present invention, when the process temperature in the stirring step is regulated to 1,550° C. or less, the amount of CO₂ gas released from the glass sheet to be obtained when the glass sheet is subjected to heat treatment under the conditions of 1,500° C. and 4 hours after having been subjected to preheating under the conditions of 900° C. and 1 hour is 8.0 μL/g or less, preferably 5.0 μL/g or less, more preferably 3.0 μL/g or less, particularly preferably 2.0 μL/g or less. When the amount of CO₂ gas released from the glass sheet when the glass sheet is subjected to the heat treatment is too large, the number of bubbles in the glass caused by the stirring reboil becomes excessively large.

After that, the molten glass is supplied into the forming apparatus and formed into a flat sheet shape having a predetermined thickness and surface quality, and then cut into a predetermined size to become a glass product (glass sheet). As a forming method, for example, an overflow down-draw method or a float method may be adopted. In particular, an overflow down-draw method is preferred because a glass sheet having a smooth surface without polishing can be produced.

The glass sheet produced as described above is used as a substrate of, for example, a liquid crystal display or an OLED display.

### EXAMPLES

<Production of Base Glass>

A glass batch was obtained by blending and mixing glass raw materials so that a glass comprising as a glass composition, in terms of the following oxides in mass %, 58.8% of SiO₂, 19% of Al₂O₃, 6.5% of B₂O₃, 2.5% of MgO, 6.5% of CaO, 0.5% of SrO, 6% of BaO, and 0.2% of SnO₂ was obtained. A base glass was obtained by melting and forming the glass batch. The base glass had a strain point of 690° C. and a temperature at 10^{2.5} dPa·s of 1,540° C.

<Production of Glass A>

100 g in total of a base glass having a particle diameter of 5.6 mm or less was weighed, and then was loaded into a platinum crucible to be melted under the conditions of 1,500° C. and 1 hour, and then the temperature was increased to 1,650° C. After completion of the temperature increase, the resultant was decompressed to 10 kPa and was kept for 2 hours. After that, the molten glass in the platinum crucible was cooled, and removed from the platinum crucible to produce a bulk-form glass A.

<Production of Glass B>

100 g in total of the bulk-form base glass was weighed, and then was loaded into a platinum crucible to be melted under the conditions of 1,500° C. and 1 hour. After that, the molten glass in the platinum crucible was cooled without decompression treatment, and removed from the platinum crucible to produce a bulk-form glass B.

<Measurement of Dissolved Amount of CO₂ Gas>

The glass A and the glass B were partially pulverized to have a particle diameter of from 2.0 mm to 5.6 mm, classified, washed, and then dried. 1.0 g in total of the glasses after the classification were weighed, and then the glasses were subjected to preheating under the conditions of 900° C. and 1 hour to remove CO₂ gas adsorbed on glass surfaces, and were then subjected to heat treatment under the conditions of 1,500° C. and 4 hours. The total amounts of CO₂ gas released during this period of time were each measured with a mass spectrometer.

<Production of Foreign Glass 1>

A glass batch was obtained by blending and mixing glass raw materials so that a glass comprising as a glass composition, in terms of the following oxides in mass %, 64.8% of SiO₂, 16.5% of Al₂O₃, 5.5% of B₂O₃, 2% of MgO, 5.5% of CaO, 0.5% of SrO, 5% of BaO, and 0.2% of SnO₂ was obtained. 100 g of the glass batch was loaded into a platinum crucible to be melted under the conditions of 1,500° C. and 2 hours, and then the temperature was increased to 1,650° C. After completion of the temperature increase, the resultant was kept for 1 hour. After that, the obtained glass was subjected to water granulation, was dried, and was then pulverized to have a particle diameter of 5.6 mm or less. The resultant was melted again under the conditions of 1,500° C. and 2 hours. The melting operation was repeated twice. The obtained glass was further subjected to water granulation, was dried, and was then pulverized to have a particle diameter of 5.6 mm or less. The resultant was loaded into a platinum crucible and was melted under the conditions of 1,600° C. and 1 hour. The resultant was decompressed to 10 kPa, and was then kept for 1 hour after the temperature was increased to 1,650° C. After that, the molten glass in the platinum crucible was cooled, and was removed from the platinum crucible to produce a foreign glass 1 which was in a bulk form, homogeneous, and free of bubbles.

<Stirring Test: Sample No. 1>

50 g of the glass A and 50 g of the foreign glass 1 were loaded into a platinum crucible while being superimposed on each other, and the resultant was subjected to preheating under the conditions of 900° C. and 2 hours to remove CO₂ gas adsorbed on the surface, and was then heated to melt under the conditions of 1,450° C. and 10 minutes.

After the melting, a stirrer made of platinum (paddle type: 20 mm×10 mm×2 mm, shaft diameter: 6 mm) was slowly inserted from above to a position at about 10 mm from a bottom surface of the platinum crucible, and the resultant was kept for 1 hour to remove air bubbles included at the time of the insertion. Next, stirring was performed with a stirrer at 10 rpm for 5 minutes, and after the stirring, the stirrer was slowly taken out. After that, the molten glass in the platinum crucible was cooled and removed from the platinum crucible to produce a bulk-form glass (Sample No. 1).

In the obtained bulk-form glass, the number of bubbles included in a region (φ20 mm×10 mm) stirred with the stirrer was counted, and the number density of bubbles was calculated. After that, a gas component of the bubbles was analyzed with a mass spectrometer.

<Stirring Test: Sample No. 2>50 g of the glass B and 50 g of the foreign glass 1 were loaded in a platinum crucible while being superimposed on each other, and the resultant was subjected to preheating under the conditions of 900° C. and 2 hours to remove CO₂ gas adsorbed on the surface, and was then heated to melt under the conditions of 1,450° C. and 10 minutes.

After the melting, a stirrer made of platinum (paddle type: 20 mm×10 mm×2 mm, shaft diameter: 6 mm) was slowly inserted from above to a position at about 10 mm from a bottom surface of the platinum crucible, and the resultant was kept for 1 hour to remove air bubbles included at the time of the insertion. Next, stirring was performed with a stirrer at 10 rpm for 5 minutes, and after the stirring, the stirrer was slowly taken out. After that, the molten glass in the platinum crucible was cooled and removed from the platinum crucible to produce a bulk-form glass (Sample No. 2).

In the obtained bulk-form glass, the number of bubbles included in a region (φ20 mm×10 mm) stirred with the stirrer was counted, and the number density of bubbles was calculated. After that, a gas component of the bubbles was analyzed with a mass spectrometer.

<Test Results>

Example (Sample No. 1) and Comparative Example (Sample No. 2) of the present invention are shown in Table 1.

TABLE 1

| | Sample No. 1 | Sample No. 2 |
|---|---|---|
| Glass used | Glass A 1.6 | Glass B 5.8 |
| Dissolved amount of | | |
| CO₂ gas (μL/g) | | |
| Number density of | 1,000 | 6,100 |
| bubbles (bubbles/kg) | | |
| Main component of | N₂ | CO₂ |
| bubbles | | |

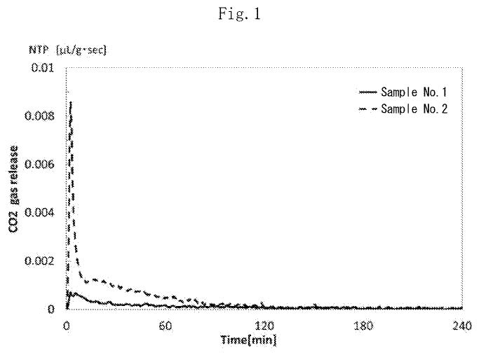

Further, CO₂ gas release rates of the glass A and the glass B when the glasses were each subjected to heat treatment under the conditions of 1,500° C. and 4 hours were measured. The results are shown in FIG. 1.

As apparent from Table 1 and FIG. 1, the glass A had a smaller dissolved amount of CO₂ gas than the glass B. As a result, the number density of bubbles of Sample No. 1 was smaller than that of Sample No. 2. In addition, while the bubbles of Sample No. 1 contained, as a main component, N₂ derived from air occurring at the time of the insertion of the stirrer and at the time of stirring, the bubbles of Sample No. 2 contained, as a main component, CO₂ derived from stirring reboil. From the results of the foregoing, it is found that when the dissolved amount of CO₂ gas in the glass is reduced, the stirring reboil can be suppressed.

<Production of Foreign Glass 2>

A glass batch was obtained by blending and mixing glass raw materials so that a glass comprising as a glass composition, in terms of the following oxides in mass %, 67.8% of SiO₂, 15% of Al₂O₃, 5% of B₂O₃, 2% of MgO, 5% of CaO, 0.5% of SrO, 4.5% of BaO, and 0.2% of SnO₂ was obtained. After that, a foreign glass 2 which was in a bulk form, homogeneous, and free of bubbles was produced by the same method as in the case of the foreign glass 1.

<Stirring Test: Sample No. 3>

The same stirring test as described above was performed using a combination of 50 g of the glass B and 50 g of the foreign glass 2 to provide Sample No. 3.

<Stirring Test: Samples No. 4 and No. 5>

Each of a combination of 50 g of the glass B and 50 g of the foreign glass 1 and a combination of 50 g of the glass B and 50 g of the foreign glass 2 was subjected to preheating under the conditions of 900° C. and 2 hours to remove CO₂ gas adsorbed on the surface, and was then heated to melt under the conditions of 1,600° C. and 10 minutes. The stirring test was hereinafter performed under the same conditions as described above to provide Samples No. 4 and No. 5.

<Test Results>

Example (Sample No. 3) and Comparative Examples (Samples No. 4 and No. 5) of the present invention are shown in Table 2.

TABLE 2

| | Sample No. 3 | Sample No. 4 | Sample No. 5 |
|---|---|---|---|
| Glass | Glass B | Glass B | Glass B |
| composition | Foreign | Foreign | Foreign |
| | glass 2 | glass 1 | glass 2 |
| Stirring | 1,450 | 1,600 | 1,600 |
| temperature (° C.) | | | |
| Number Density of | 2,800 | 190,000 | 280,000 |
| bubbles (bubbles/kg) | | | |

As apparent from Table 2, Sample No. 3 had a stirring temperature of 1,450° C., and hence had a smaller number density of bubbles than each of Samples No. 4 and No. 5. Accordingly, it is found that, when the molten glass is stirred at low temperature, the stirring reboil can be suppressed.

1. A glass sheet, which releases CO₂ gas in an amount of 5.0 μL/g or less when the glass sheet is subjected to heat treatment under the conditions of 1,500° C. and 4 hours after having been subjected to preheating under the conditions of 900° C. and 1 hour.

2. The glass sheet according to claim 1, wherein the glass sheet comprises as a glass composition, in terms of the following oxides in mass %, 50% to 70% of SiO₂, 15% to 22% of Al₂O₃, 0.1% to 15% of B203, 0% to 8% of MgO, 3% to 10% of CaO, 0% to 8% of SrO, and 0% to 15% of BaO, and is substantially free of an alkali metal oxide.

3. The glass sheet according to claim 1, wherein the glass sheet has a temperature at 10^{2.5} dPa·s of from 1,530° C. to 1,680° C.

4. The glass sheet according to claim 1, wherein the glass sheet is used as a substrate of a liquid crystal display or an OLED display.

5. A method of manufacturing a glass sheet, comprising:
a blending step of blending and mixing glass raw materials so that a glass having a temperature at 10^{2.5} dPa·s of from 1,530° C. to 1,680° C. is obtained, to thereby produce a glass batch;
a melting step of loading the glass batch into a melting furnace to obtain molten glass;
a stirring step of stirring the molten glass at a temperature of 1,550° C. or less; and
a forming step of, after supplying the molten glass after the stirring into a forming apparatus, forming the molten glass into a sheet shape to obtain a glass sheet.

6. The method of manufacturing a glass sheet according to claim 5, wherein the forming step comprises forming the molten glass into a sheet shape to obtain a glass sheet which releases CO₂ gas in an amount of 8.0 μL/g or less when the glass sheet is subjected to heat treatment at 1,500° C. for 4 hours after having been subjected to preheating at 900° C. for 1 hour.

7. The glass sheet according to claim 2, wherein the glass sheet has a temperature at 10^{2.5} dPa·s of from 1,530° C. to 1,680° C.

8. The glass sheet according to claim 2, wherein the glass sheet is used as a substrate of a liquid crystal display or an OLED display.
